(19) United States
(12) Patent Application Publication
(10) Pub. No.: US 2010/0308274 A1
(43) Pub. Date: Dec. 9, 2010

(54) Pulsed Driven Light Emissive Device and Composition Therefor

(75) Inventor: Richard Wilson, Cambridge (GB)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignees: Cambridge Display Technology Ltd., Cambridgeshire (GB); Sumation Co. Ltd., Tokyo (JP)

(21) Appl. No.: 12/863,961

(22) PCT Filed: Jan. 22, 2009
(86) PCT No.: PCT/GB09/00170

§ 371 Date: Aug. 23, 2010

(30) Foreign Application Priority Data
Jan. 23, 2008 (GB) GB 0801224.7

(51) Int. Cl. C09K 11/06

(52) U.S. Cl. 252/301.35

(57) ABSTRACT

A pulsed-driven device, such as a display, comprises an organic light-emitting composition comprising a host material and a blended or bound phosphorescent emitter. The phosphorescent emitter is present in the host material at a concentration of greater than 10 wt. %, and the host material has a higher triplet energy level than the phosphorescent emitter. The concentration at which the phosphorescent emitter is at peak efficiency in the host material is greater than 10 wt. %, and the composition does not include a fluorescent emitter, so that emission from the composition in use is substantially all phosphorescence.

The present invention is concerned with light emissive devices, for example passive matrix displays, driven by pulsed driving conditions. The present invention is further concerned with new compositions that may be used in such light emissive devices. The present invention is further concerned with the lifetime properties of such compositions, and in particular increasing the lifetime of a composition in a device driven by pulsed driving conditions.

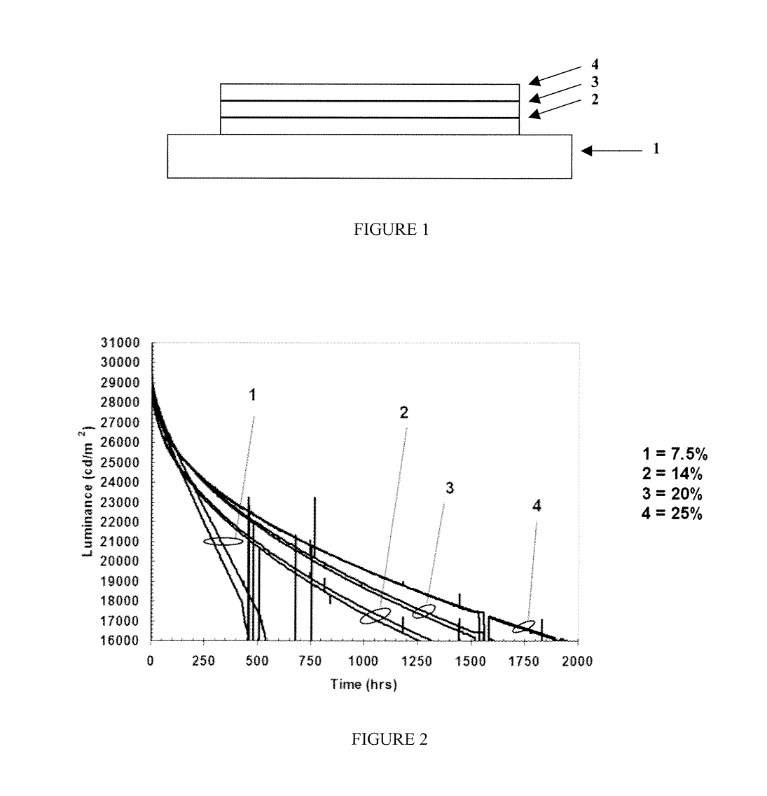

Many displays consist of a matrix of pixels, formed at the intersection of rows and columns deposited on a substrate. Each pixel is, for example, an organic light-emitting diode (OLED), such as a polymer LED (PLED). With reference to FIG. 1, the architecture of a typical OLED comprises a transparent glass or plastic substrate 1, an anode 2 and a cathode 4. An organic electroluminescent (emitting) layer 3 is provided between anode 2 and cathode 4.

Coloured displays are formed by positioning matrices of red, green and blue pixels very close together. To control the pixels, and so form the image required, either ‘passive’ or ‘active’ matrix driver methods are used.

Active matrix displays incorporate a transistor (TFT) in series with each pixel which provides control over the current and hence the brightness of individual pixels. Lower currents can flow down the control wires since these have only to program the TFT driver, and the wires can be finer as a result. Also, the transistor is able to hold the current setting, keeping the pixel at the required brightness, until it receives another control signal. DC driving conditions typically are used for an active matrix display.

In passive matrix systems, each row and each column of the display has its own driver, and to create an image, the matrix is rapidly scanned to enable every pixel to be switched on or off as required. The controlling current has to be present whenever the pixel is required to light up.

As described in Proc. of SPIE Vol 2800 (2003) “Organic Light-Emitting Materials and Devices”, the principle of passive matrix addressing is rather straightforward and uses the eye's insensitivity to the fast re-positioning of light generation. Instead of simultaneously addressing all the pixels needed to display an image frame, in the passive matrix approach, the different pixels are addressed in a sequence via a row to row scrolling. The intensity of the short illumination is much more intense than when all the pixels are generating light for the total frame time (the number of rows times the average overall brightness needed). If the refresh rate of the whole frame is high enough (i.e. above what is known as the critical fusion frequency), the human eye observes the scrolled picture as a standing picture with an average brightness. The advantage of passive matrix driving is the simple substrate structure allowing for easy customization and low substrate costs. Pulsed driving conditions typically are used for a passive matrix display.

Synthetic Metals 91 (1997) 3-7 and Synthetic Metals 113 (2000) 155-159 provide information on the structure of passive matrix organic LEDs, the contents of which are hereby incorporated by reference. Reference is made in particular to FIG. 11 (c) in Synthetic Metals 91 (1997) 3-7, which shows deposition of the organic emitter layer by evaporation, followed by evaporation of the cathode. Solution deposition (e.g. inkjet printing) of the emitter layer is equally applicable to this structure. The background section of the Synthetic Metals 113 (2000) 155-159 article provides detail on how the cathode is patterned into stripes using a photoresist material.

An important parameter is the lifetime of a display.

According to Proc. Of SPIE Vol 2800 (2003) “Organic Light-Emitting Materials and Devices” lifetime measurements are mostly performed at dc driving. However, it is said that the lifetime of light-emitting materials for passive matrix applications should also be tested using the pulsed driving conditions experienced in full colour displays.

In the past, blending of phosphorescent materials into a semiconductive layer has been studied. Good results have been achieved for OLED's based on blends incorporating a phosphorescent dopant and a small molecule or a non-conjugated polymer host such as polyvinylcarbazole. Conjugated polymers have also been disclosed as hosts.

WO 03/091355 discloses a material capable of luminescence comprising a polymer or oligomer; and an organometallic group characterized in that the polymer or oligomer is at least partially conjugated and the organometallic group is covalently bound to the polymer or oligomer. Luminescence predominantly is phosphorescence. It is stated that, generally, it is preferred that the organometallic is present in the material in an amount in the range of from 0.5 to 70% by weight, more preferably 1 to 10% by weight.

Adv. Funct. Mater. 2006, 16, 611-617 is concerned with white light emitting diodes based on Iridium complexes. Blends of “BlueJ”:PVK:Ir(PBPP)₃:Ir(PIQ)₃ are disclosed. Ir(PBPP)₃ is present in the blend at a level of 9.7 wt. %. Ir(PIQ)₃ is present in the blend at a level of 0.3 wt. %.

Applied Physics Letters 88, 251110 (2006) discloses white light emitting diodes based on PVK with blue fluorescent and orange phosphorescent materials. Blue fluorescent emission is obtained from small molecule DPAVBi. Orange phosphorescent emission is obtained from Os(bpftz). PVK-PBD is used as host. Os(bpftz) is used at a level of 0.1 mol % (=0.58 wt %) and 0.04 mol % (=0.23 wt %) relative to PVK monomer units.

Adv. Mater. 2007, 19, 739-743 discloses red-emission polymer phosphorescent light-emitting diodes. It is said that pure red emission from dopants was obtained at 4-6 wt. % dopant in a polyfluorene host polymer. A dopant concentration of 8-10 wt. % is referred to as being “high”. Concentrations above 8 wt. % were not tested.

In relation to OLEDs using phosphorescent emitters, the present inventors have identified a problem to provide improved compositions containing said phosphorescent emitters, particularly compositions with improved lifetimes when used in a device.

The present inventors have unexpectedly solved this problem by providing, a pulsed-driven light emissive device comprising an organic light-emitting composition comprising a host material and a phosphorescent emitter; characterized in that the phosphorescent emitter is present in the host material at a concentration of greater than 7.5 wt. %.

According to the present invention, the concentration of the phosphorescent emitter in the host material is measured relative to the wt % of host material only. Where the composition further contains other components, e.g. a second emitter, said other components do not form part of the calculation.

The present inventors have found that, for a pulsed-driven display or other light emissive device, when the phosphorescent emitter is present in the host material at a concentration of greater than 7.5 wt. % lifetime is significantly improved. This is surprising, because a high concentration of emitter is generally regarded as being undesirable due to the phenomenon of “concentration quenching”. For example, Kawamura et al, Appl. Phys. Lett. 86, 071104, 2005 describes concentration quenching effects for red, green and blue phosphorescent emitters. For the red and green emitters, a maximum of η_{PL} was achieved for a concentration of 2 wt. % emitter in the CBP host. For the blue emitter in the CBP host, a different η_{PL} curve was obtained. This was explained by reference to back energy transfer from the T1 energy level of the blue emitter to the T1 energy level of CBP. In order to confirm this, further compositions of the blue emitter in a high T1 energy level host (mCP) were prepared. These confirmed a maximum η_{PL} for an emitter concentration of 2 wt. % in the mCP host.

In the prior art, lifetime measurements have been made under dc driving conditions. Optimum lifetimes under dc driving conditions are widely held to be achieved at much lower concentrations. The increased lifetimes observed under pulsed driving conditions for higher concentrations of phosphorescent emitter were completely unexpected.

According to the present invention, the phosphorescent emitter preferably is present in the host material at a concentration of greater than 10 wt. %, more preferably in the range of 10 to 25 wt. %, still more preferably in the range of 14 to 25 wt. %, still more preferably in the range of 15 to 25 wt. %, still more preferably in the range of 20 to 25 wt. %, most preferably about 20 wt. %.

The phosphorescent emitter preferably is a red emitter or green emitter. By “red emitter” is meant a material that by phosphorescence emits radiation having a wavelength in the range of 600 to 750 nm, preferably 600 to 700 nm, more preferably 610 to 650 nm and most preferably having an emission peak around 650 to 660 nm. By “green emitter” is meant a material that by phosphorescence emits radiation having a wavelength in the range of 510 to 580 nm, preferably 510 to 570 nm.

The phosphorescent emitter preferably comprises a complex of Pt, Pd, Os, Au, Ru, Re, Ru or Ir, most preferably a complex of Ir.

The host material preferably is blended with the phosphorescent emitter. However, this is not essential and the host material may be bound to the phosphorescent emitter, for example in the manner described in WO 03/091355.

The host material may be a polymer or a small molecule, preferably a polymer. Said polymer may be conjugated or non-conjugated.

Preferably, in a pulsed-driven device the host material is a blue host material. By “blue host material” is meant a host material capable of emitting radiation having a wavelength in the range of 400 to 500 nm, preferably 430 to 500 nm, by electroluminescence. However, it will be appreciated that the blue host material preferably emits little or no blue light as a result of most or all of the excited state energy of the blue host material being transferred to the phosphorescent emitter.

Preferably, the host material has a T₁ energy level that is higher than that of the phosphorescent emitter in order to avoid back-transfer of energy from the host to the emitter. In particular, it is preferred that the host has a T1 energy level at least 100 meV higher than that of the emitter.

Preferably, the host material is a charge transport material, that is a material capable of transporting holes and/or electrons. A charge transport material is a material having a higher charge mobility in a device than the phosphorescent emitter used in that device. Hole and electron transport materials are well known to the skilled person. Charge mobility may be measured using a single carrier device.

An OLED typically comprises an anode, a cathode, and an emitting layer located between the anode and the cathode.

The organic light-emitting device generally will comprise a transparent glass or plastic substrate, an anode and cathode. In this case, the composition comprising a host material and a phosphorescent emitter will be present in an emitting layer located between the anode and the cathode.

In a practical device, at least one of the electrodes is semi-transparent in order that light may be absorbed (in the case of a photoresponsive device) or emitted (in the case of an OLED). Where the anode is transparent, it typically comprises indium tin oxide.

In particular, it is desirable to provide a conductive hole injection layer, which may be formed from a conductive organic or inorganic material provided between the anode and the emitting layer to assist hole injection from the anode. Examples of doped organic hole injection materials include doped poly(ethylene dioxythiophene) (PEDT), in particular PEDT doped with a charge-balancing polyacid such as polystyrene sulfonate (PSS) as disclosed in EP 0901176 and EP 0947123, polyacrylic acid or a fluorinated sulfonic acid, for example Nafion®; polyaniline as disclosed in U.S. Pat. No. 5,723,873 and U.S. Pat. No. 5,798,170; and poly(thienothiophene). Examples of conductive inorganic materials include transition metal oxides such as VOx MoOx and RuOx as disclosed in Journal of Physics D: Applied Physics (1996), 29(11), 2750-2753.

If present, a hole transporting layer located between the anode and the emitting layer preferably has a HOMO level of less than or equal to 5.5 eV, more preferably around 4.8-5.5 eV. HOMO levels may be measured by cyclic voltammetry, for example.

If present, an electron transporting layer located between the emitting layer and the cathode preferably has a LUMO level of around 3-3.5 eV.

The emitting layer may consist of the host material and phosphorescent emitter alone or may comprise these in combination with one or more further materials. In particular, the host material and phosphorescent emitter may be blended with hole and/or electron transporting materials as disclosed in, for example, WO 99/48160 and/or with a further emitting material.

Further layers may also be located between the anode and the cathode, for example charge transporting, charge injecting or charge blocking layers.

Typically, in the first aspect of the invention, the emitting layer will be patterned.

According to a first aspect of the present invention, there is provided a composition as specified in claims 1 to 9.

As stated above, in the composition the concentration at which the phosphorescent emitter is at it's peak efficiency in the host material is greater than 10 wt. %. The peak efficiency of the phosphorescent emitter in the host material can be measured in units of cd/A. A skilled person will know how to measure this. It is not necessary for the phosphorescent emitter to be present in the host material at the concentration giving the peak efficiency. It is necessary only for the phosphorescent emitter to be present in the host material at a concentration of greater than 10 wt %.

It is preferred that the host has a T1 energy level at least 100 meV higher than that of the emitter.

Preferably, the host material is a charge transporting material, that is a material capable of transporting holes and/or electrons. A charge transport material is a material having a higher charge mobility in a device than the phosphorescent emitter used in that device. Hole and electron transporting materials are well known to the skilled person. Charge mobility may be measured using a single carrier device.

Preferably, in the composition according to the second aspect, the phosphorescent emitter is present in the host material at a concentration in the range of 10 to 25 wt. %, still more preferably in the range of 14 to 25 wt. %, still more preferably in the range of 15 to 25 wt. %, still more preferably in the range of 20 to 25 wt. %, most preferably about 20 wt. %.

In the composition according to the second aspect, preferably, the host material is blended with the phosphorescent emitter. However, this is not essential and the host material may be bound to the phosphorescent emitter, for example in the manner described in WO 03/091355.

Preferably, the phosphorescent emitter is a red emitter or green emitter.

Preferably, the phosphorescent emitter comprises a complex of Pt, Pd, Os, Au, Ru, Re, Ru or Ir, most preferably a complex of Ir.

Preferably, the host material is a blue host material.

Preferably, the host material is a polymer. Said polymer may be conjugated or non-conjugated.

A further aspect of the present invention provides an organic light-emitting device (OLED) containing a composition as defined in claims 1 to 9.

An organic light-emitting device according to the invention typically comprises an anode, a cathode, and an emitting layer located between the anode and the cathode.

The organic light-emitting device according to the invention generally will comprise a transparent glass or plastic substrate, an anode and cathode. In this case, the composition comprising a host material and a phosphorescent emitter will be present in an emitting layer located between the anode and the cathode.

In a practical device, at least one of the electrodes is semi-transparent in order that light may be absorbed (in the case of a photoresponsive device) or emitted (in the case of an OLED). Where the anode is transparent, it typically comprises indium tin oxide.

In particular, it is desirable to provide a conductive hole injection layer, which may be formed from a conductive organic or inorganic material provided between the anode and the emitting layer to assist hole injection from the anode. Examples of doped organic hole injection materials include doped poly(ethylene dioxythiophene) (PEDT), in particular PEDT doped with a charge-balancing polyacid such as polystyrene sulfonate (PSS) as disclosed in EP 0901176 and EP 0947123, polyacrylic acid or a fluorinated sulfonic acid, for example Nafion®; polyaniline as disclosed in U.S. Pat. No. 5,723,873 and U.S. Pat. No. 5,798,170; and poly(thienothiophene). Examples of conductive inorganic materials include transition metal oxides such as VOx MoOx and RuOx as disclosed in Journal of Physics D: Applied Physics (1996), 29(11), 2750-2753.

If present, a hole transporting layer located between the anode and the emitting layer preferably has a HOMO level of less than or equal to 5.5 eV, more preferably around 4.8-5.5 eV. HOMO levels may be measured by cyclic voltammetry, for example.

If present, an electron transporting layer located between the emitting layer and the cathode preferably has a LUMO level of around 3-3.5 eV.

The emitting layer in an OLED according to the invention may consist of the host material and phosphorescent emitter alone or may comprise these in combination with one or more further materials. In particular, the host material and phosphorescent emitter may be blended with hole and/or electron transporting materials as disclosed in, for example, WO 99/48160 and/or with a further emitting material.

Further layers may also be located between the anode and the cathode, for example charge transporting, charge injecting or charge blocking layers.

A further aspect of the invention provides a display comprising an organic light-emitting device as specified in claim 12 or 13. The display according to this aspect may be a pulsed-driven device such as a passive matrix device, or any other form of display, for example an active matrix device.

The emitting layer of the OLED in the display according to the present invention may be patterned or unpatterned.

A device comprising an unpatterned layer may be used an illumination source, for example. A white light emitting device is particularly suitable for this purpose.

A device comprising a patterned layer may be, for example, an active matrix display or a full colour passive matrix display. In the case of an active matrix display, a patterned electroluminescent layer is typically used in combination with a patterned anode layer and an unpatterned cathode. In the case of a passive matrix display, the anode layer is formed of parallel stripes of anode material, and parallel stripes of electroluminescent material and cathode material arranged perpendicular to the anode material wherein the stripes of electroluminescent material and cathode material are typically separated by stripes of insulating material (“cathode separators”) formed by photolithography.

A pulsed-driven light emissive device according to the present invention may be a display, or a print head, or a light source for use in an imaging device such as a scanner, printer or photocopier.

Embodiments of the present invention will now be described, by way of example only, with reference to the attached figures in which:

FIG. 1 shows the architecture of an OLED.

FIG. 2 shows a luminance vs. time plot for four different compositions according to the invention.

Numerous hosts for phosphorescent emitters are described in the prior art. The host material should have a T₁ energy level sufficiently high for excited state energy to be transferred from the T₁ energy level of the host to the T1 level of the emitter. Preferably, the host has a T₁ energy level sufficiently high to prevent energy back-transfer from the T₁ energy level of the emitter, and in particular a T₁ energy level higher than that of the emitter. However, in some cases the T₁ energy level of the host may be the same, or even lower, than that of the emitter. Examples of host materials include “small molecule” hosts such as 4,4′-bis(carbazol-9-yl)biphenyl), known as CBP, and (4,4′,4″-tris(carbazol-9-yl)triphenylamine), known as TCTA, disclosed in Ikai et al., Appl. Phys. Lett., 79 no. 2, 2001, 156; and triarylamines such as tris-4-(N-3-methylphenyl-N-phenyl)phenylamine, known as MTDATA. Polymers are also known as hosts, in particular homopolymers such as poly(vinyl carbazole) disclosed in, for example, Appl. Phys. Lett. 2000, 77(15), 2280; polyfluorenes in Synth. Met. 2001, 116, 379, Phys. Rev. B 2001, 63, 235206 and Appl. Phys. Lett. 2003, 82(7), 1006; poly[4-(N-4-vinylbenzyloxyethyl, N-methylamino)-N-(2,5-di-tert-butylphenylnapthalimide] in Adv. Mater. 1999, 11(4), 285; and poly(para-phenylenes) in J. Mater. Chem. 2003, 13, 50-55. Copolymers are also known as hosts.

Preferred phosphorescent metal complexes comprise optionally substituted complexes of formula 1:

ML¹_{q}L²ᵣL³ₛ 1
wherein M is a metal; each of L¹, L² and L³ is a coordinating group; q is an integer; r and s are each independently 0 or an integer; and the sum of (a. q)+(b. r)+(c.s) is equal to the number of coordination sites available on M, wherein a is the number of coordination sites on L¹, b is the number of coordination sites on L² and c is the number of coordination sites on L³.

Heavy elements M induce strong spin-orbit coupling to allow rapid intersystem crossing and emission from triplet or higher states (phosphorescence). Suitable heavy metals M include:

lanthanide metals such as cerium, samarium, europium, terbium, dysprosium, thulium, erbium and neodymium; and

d-block metals, in particular those in rows 2 and 3 i.e. elements 39 to 48 and 72 to 80, in particular ruthenium, rhodium, palladium, rhenium, osmium, iridium, platinum and gold.

Suitable coordinating groups for the f-block metals include oxygen or nitrogen donor systems such as carboxylic acids, 1,3-diketonates, hydroxy carboxylic acids, Schiff bases including acyl phenols and iminoacyl groups. As is known, luminescent lanthanide metal complexes require sensitizing group(s) which have the triplet excited energy level higher than the first excited state of the metal ion. Emission is from an f-f transition of the metal and so the emission colour is determined by the choice of the metal. The sharp emission is generally narrow, resulting in a pure colour emission useful for display applications.

The d-block metals are particularly suitable for emission from triplet excited states. These metals form organometallic complexes with carbon or nitrogen donors such as porphyrin or bidentate ligands of formula 2:

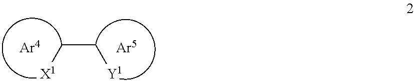

wherein Ar⁴ and Ar⁵ may be the same or different and are independently selected from optionally substituted aryl or heteroaryl; X¹ and Y¹ may be the same or different and are independently selected from carbon or nitrogen; and Ar⁴ and Ar⁵ may be fused together. Ligands wherein X¹ is carbon and Y¹ is nitrogen are particularly preferred.

Examples of bidentate ligands are illustrated below:

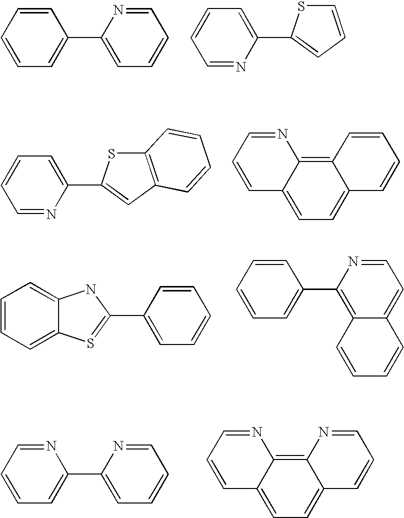

The colour of emission of the phosphorescent emitter may be tuned by appropriate selection of metal, ligand and substituents therefor. For example phosphorescent iridium complexes include red phosphorescent emitters comprising thienyl-pyridine ligands as disclosed in Appl. Phys. Letters 2005, 86, 161104 or phenyl-quinoline or phenyl-isoquinoline ligands as disclosed in Tsuboyama et al, J. Am. Chem. Soc. 2003, 125, 12971-12979; green phosphorescent emitters comprising phenyl-pyridine ligands; and blue phosphorescent emitters comprising phenyl-triazole ligands as disclosed in WO 2004/101707 or fluorinated phenylpyridine ligands.

Each of Ar⁴ and Ar⁵ may carry one or more substituents. Two or more of these substituents may be linked to form a ring, for example an aromatic ring. Particularly preferred substituents include fluorine or trifluoromethyl which may be used to blue-shift the emission of the complex as disclosed in WO 02/45466, WO 02/44189, US 2002-117662 and US 2002-182441; alkyl or alkoxy groups as disclosed in JP 2002-324679; carbazole which may be used to assist hole transport to the complex when used as an emissive material as disclosed in WO 02/81448; bromine, chlorine or iodine which can serve to functionalise the ligand for attachment of further groups as disclosed in WO 02/68435 and EP 1245659; and dendrons which may be used to obtain or enhance solution processability of the metal complex as disclosed in WO 02/66552.

A light-emitting dendrimer typically comprises a light-emitting core bound to one or more dendrons, wherein each dendron comprises a branching point and two or more dendritic branches. Preferably, the dendron is at least partially conjugated, and at least one of the core and dendritic branches comprises an aryl or heteroaryl group. In one preferred embodiment, the branch group comprises other ligands suitable for use with d-block elements include diketonates, in particular acetylacetonate (acac); triarylphosphines and pyridine, each of which may be substituted.

Main group metal complexes show ligand based, or charge transfer emission. For these complexes, the emission colour is determined by the choice of ligand as well as the metal.

The host material and metal complex may be combined in the form of a physical blend. Alternatively, the metal complex may be chemically bound to the host material. In the case of a polymeric host, the metal complex may be chemically bound as a substituent attached to the polymer backbone, incorporated as a repeat unit in the polymer backbone or provided as an end-group of the polymer as disclosed in, for example, EP 1 245 659, WO 02/31896, WO 03/18653 and WO 03/22908.

The cathode is selected from materials that have a workfunction allowing injection of electrons into the electroluminescent layer. Other factors influence the selection of the cathode such as the possibility of adverse interactions between the cathode and the electroluminescent material. The cathode may consist of a single material such as a layer of aluminium. Alternatively, it may comprise a plurality of metals, for example a bilayer of a low workfunction material and a high workfunction material such as calcium and aluminium as disclosed in WO 98/10621; elemental barium as disclosed in WO 98/57381, Appl. Phys. Lett. 2002, 81(4), 634 and WO 02/84759; or a thin layer of metal compound, in particular an oxide or fluoride of an alkali or alkali earth metal, to assist electron injection, for example lithium fluoride as disclosed in WO 00/48258; barium fluoride as disclosed in Appl. Phys. Lett. 2001, 79(5), 2001; and barium oxide. In order to provide efficient injection of electrons into the device, the cathode preferably has a workfunction of less than 3.5 eV, more preferably less than 3.2 eV, most preferably less than 3 eV. Work functions of metals can be found in, for example, Michaelson, J. Appl. Phys. 48(11), 4729, 1977.

The cathode may be opaque or transparent. Transparent cathodes are particularly advantageous for active matrix devices because emission through a transparent anode in such devices is at least partially blocked by drive circuitry located underneath the emissive pixels. A transparent cathode will comprises a layer of an electron injecting material that is sufficiently thin to be transparent. Typically, the lateral conductivity of this layer will be low as a result of its thinness. In this case, the layer of electron injecting material is used in combination with a thicker layer of transparent conducting material such as indium tin oxide.

It will be appreciated that a transparent cathode device need not have a transparent anode (unless, of course, a fully transparent device is desired), and so the transparent anode used for bottom-emitting devices may be replaced or supplemented with a layer of reflective material such as a layer of aluminium. Examples of transparent cathode devices are disclosed in, for example, GB 2348316.

Optical devices tend to be sensitive to moisture and oxygen. Accordingly, the substrate preferably has good barrier properties for prevention of ingress of moisture and oxygen into the device. The substrate is commonly glass, however alternative substrates may be used, in particular where flexibility of the device is desirable. For example, the substrate may comprise a plastic as in U.S. Pat. No. 6,268,695 which discloses a substrate of alternating plastic and barrier layers or a laminate of thin glass and plastic as disclosed in EP 0 949 850.

The device is preferably encapsulated with an encapsulant (not shown) to preventingress of moisture and oxygen. Suitable encapsulants include a sheet of glass, films having suitable barrier properties such as alternating stacks of polymer and dielectric as disclosed in, for example, WO 01/81649 or an airtight container as disclosed in, for example, WO 01/19142. A getter material for absorption of any atmospheric moisture and/or oxygen that may permeate through the substrate or encapsulant may be disposed between the substrate and the encapsulant.

The embodiment of FIG. 1 illustrates a device wherein the device is formed by firstly forming an anode on a substrate, followed by deposition of an electroluminescent layer, and a cathode, however it will be appreciated that devices of the invention could also be formed by firstly forming a cathode on a substrate, followed by deposition of an electroluminescent layer, and an anode.

Suitable electroluminescent and/or charge transporting polymers include, but are not limited to, poly(arylene vinylenes) such as poly(p-phenylene vinylenes) and polyarylenes.

Polymers preferably comprise a first repeat unit selected from arylene repeat units as disclosed in, for example, Adv. Mater. 2000 12(23) 1737-1750 and references therein. Exemplary first repeat units include: 1,4-phenylene repeat units as disclosed in J. Appl. Phys. 1996, 79, 934; fluorene repeat units as disclosed in EP 0 842 208; indenofluorene repeat units as disclosed in, for example, Macromolecules 2000, 33(6), 2016-2020; and spirofluorene repeat units as disclosed in, for example EP 0 707 020. Each of these repeat units is optionally substituted. Examples of substituents include solubilising groups such as C₁₋₂₀ alkyl or alkoxy; electron withdrawing groups such as fluorine, nitro or cyano; and substituents for increasing the glass transition temperature (Tg) of the polymer.

Particularly preferred polymers comprise optionally substituted, 2,7-linked fluorenes, most preferably repeat units of formula 3:

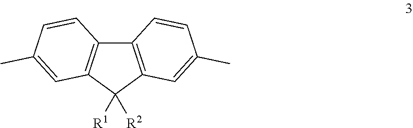

wherein R¹ and R² are independently selected from hydrogen or optionally substituted alkyl, alkoxy, aryl, arylalkyl, heteroaryl and heteroarylalkyl. More preferably, at least one of R¹ and R² comprises an optionally substituted C₄-C₂₀ alkyl or aryl group.

Polymers may provide one or more of the functions of hole transport, electron transport and emission depending on which layer of the device it is used in and the nature of co-repeat units.

For example, in particular:

a homopolymer of fluorene repeat units, such as a homopolymer of 9,9-dialkylfluoren-2,7-diyl, may be utilised to provide electron transport.

a copolymer comprising triarylamine repeat unit may provide hole transport or emission. Repeat units of formula 4 are particularly preferred:

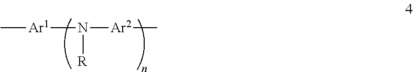

wherein Ar¹ and Ar² are optionally substituted aryl or heteroaryl groups, n is greater than or equal to 1, preferably 1 or 2, and R is H or a substituent, preferably a substituent. R is preferably alkyl or aryl or heteroaryl, most preferably aryl or heteroaryl. Any of the aryl or heteroaryl groups in the unit of formula 1 may be substituted. Preferred substituents include alkyl and alkoxy groups. Any of the aryl or heteroaryl groups in the repeat unit of Formula 1 (i.e. Ar¹, Ar² and R in the case where R is aryl or heteroaryl) may be be linked by a direct bond or a divalent linking atom or group. Preferred divalent linking atoms and groups include O, S; substituted N; and substituted C.

Particularly preferred units satisfying Formula 4 include units of Formulae 5 to 7:

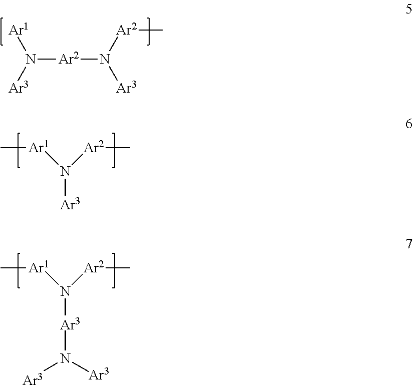

wherein Ar¹ and Ar² are as defined above; and Ar³ is optionally substituted aryl or heteroaryl. Where present, preferred substituents for Ar³ include alkyl and alkoxy groups. Any two of the aryl or heteroaryl groups Ar¹, Ar² and Ar³ may optionally be linked by a direct bond or a divalent linking group or atom. Where present, a linking bond, group or atom preferably links two aryl or heteroaryl groups that are attached to a common N atom.

Particularly preferred hole transporting polymers of this type are copolymers of the first repeat unit and a triarylamine repeat unit.

Electroluminescent copolymers may comprise an electroluminescent region and at least one of a hole transporting region and an electron transporting region as disclosed in, for example, WO 00/55927 and U.S. Pat. No. 6,353,083. If only one of a hole transporting region and electron transporting region is provided then the electroluminescent region may also provide the other of hole transport and electron transport functionality. Alternatively, an electroluminescent polymer may be blended with a hole transporting material and/or an electron transporting material. Polymers comprising one or more of a hole transporting repeat unit, electron transporting repeat unit and emissive repeat unit may provide said units in a polymer main-chain or polymer side-chain.

The different regions within such a polymer may be provided along the polymer backbone, as per U.S. Pat. No. 6,353,083, or as groups pendant from the polymer backbone as per WO 01/62869.

### Polymerisation Methods

Preferred methods for preparation of these polymers are Suzuki polymerisation as described in, for example, WO 00/53656 and Yamamoto polymerisation as described in, for example, T. Yamamoto, “Electrically Conducting And Thermally Stable π—Conjugated Poly(arylene)s Prepared by Organometallic Processes”, Progress in Polymer Science 1993, 17, 1153-1205. These polymerisation techniques both operate via a “metal insertion” wherein the metal atom of a metal complex catalyst is inserted between an aryl group and a leaving group of a monomer. In the case of Yamamoto polymerisation, a nickel complex catalyst is used; in the case of Suzuki polymerisation, a palladium complex catalyst is used.

For example, in the synthesis of a linear polymer by Yamamoto polymerisation, a monomer having two reactive halogen groups is used. Similarly, according to the method of Suzuki polymerisation, at least one reactive group is a boron derivative group such as a boronic acid or boronic ester and the other reactive group is a halogen. Preferred halogens are chlorine, bromine and iodine, most preferably bromine.

It will therefore be appreciated that repeat units and end groups comprising aryl groups as illustrated throughout this application may be derived from a monomer carrying a suitable leaving group.

Suzuki polymerisation may be used to prepare regioregular, block and random copolymers. In particular, homopolymers or random copolymers may be prepared when one reactive group is a halogen and the other reactive group is a boron derivative group. Alternatively, block or regioregular, in particular AB, copolymers may be prepared when both reactive groups of a first monomer are boron and both reactive groups of a second monomer are halogen.

As alternatives to halides, other leaving groups capable of participating in metal insertion include groups include tosylate, mesylate and triflate.

### Solution Processing

A single polymer or a plurality of polymers may be deposited from solution to form layer 5. Suitable solvents for polyarylenes, in particular polyfluorenes, include mono- or poly-alkylbenzenes such as toluene and xylene. Particularly preferred solution deposition techniques are spin-coating and inkjet printing.

Spin-coating is particularly suitable for devices wherein patterning of the electroluminescent material is unnecessary—for example for lighting applications or simple monochrome segmented displays.

Inkjet printing is particularly suitable for high information content displays, in particular full colour displays. Inkjet printing of OLEDs is described in, for example, EP 0 880 303.

Other solution deposition techniques include, for example, dip-coating, roll printing and screen printing.

If multiple layers of the device are formed by solution processing, then the skilled person will be aware of techniques to prevent intermixing of adjacent layers, for example by cross-linking of one layer before deposition of a subsequent layer or selection of materials for adjacent layers such that the material from which the first of these layers is formed is not soluble in the solvent used to deposit the second layer.

### EXAMPLES

### Example 1

Three different compositions according to the invention were prepared, in addition to a comparative composition:

Composition 1 (comparative): 7.5 wt. % phosphorescent red emitter was blended with host material

Composition 2: 14 wt. % phosphorescent red emitter was blended with host material

Composition 3: 20 wt. % phosphorescent red emitter was blended with host material

Composition 4: 25 wt. % phosphorescent red emitter was blended with host material

The phosphorescent red emitter is a dendrimer having a core comprising a red-emitting iridium complex and a dendrite based on 3,5-diphenylbenzene as disclosed in WO 02/066552.

The host material comprises a copolymer of fluorene repeat units and repeat units of formula 5.

### Example 2

The compositions from Example 1 were used to make OLEDs. The OLEDs were tested under pulsed driving conditions. The results are shown in FIG. 2.

Poly(ethylene dioxythiophene)/poly(styrene sulfonate) (PEDT/PSS), available from H C Starck of Leverkusen, Germany as Baytron P® is deposited over an indium tin oxide anode supported on a glass substrate (available from Applied Films, Colo., USA) by spin coating. A hole transporting layer of a fluorene-triarylamine copolymer is deposited over the PEDT/PSS layer by spin coating from xylene solution to a thickness of about 10 nm and heated at 180° C. for 1 hour. A composition from Example 1 is deposited over the hole transporting layer by spin-coating from xylene solution to a thickness of around 65 nm. A Ba/Al cathode is formed over the composition from Example 1 by evaporating a first layer of barium to a thickness of up to about 10 nm and a second layer of aluminium barium to a thickness of about 100 nm over the semiconducting polymer. Finally, the device is sealed using a metal enclosure containing a getter that is placed over the device and glued onto the substrate in order to form an airtight seal.

The device was driven using a pulsed drive train as follows:

−9 V in off-state

Frequency=60 Hz

Multiplex Ratio=64

In the on state the device was driven at the current required to achieve an initial peak luminance of 30,000 cd/m².

### Results

As shown in FIG. 2, a phosphorescent emitter present at a concentration of 7.5 wt. % has substantially shorter pulsed lifetime than compositions having a higher concentration of emitter. Furthermore, efficiency of exemplary compositions 2-4 is comparable with, and in some cases higher than, efficiency of comparative composition 1. This is surprising, as compositions at such high concentration of dopant would be expected to suffer from drawbacks associated with concentration quenching.

1. A composition comprising a host material and a phosphorescent emitter, wherein the phosphorescent emitter is present in the host material at a concentration of greater than 10 wt %, the host material has a higher triplet energy level than the phosphorescent emitter, the composition does not comprise a fluorescent emitter so that emission from the composition is substantially all phosphorescence, and the phosphorescent emitter has a peak efficiency in the host material at a concentration of greater than 10 wt %.

2. A composition according to claim 1, wherein the phosphorescent emitter is present in the host material at a concentration in a range 10 wt % to 25 wt %.

3. A composition according to claim 1, wherein the phosphorescent emitter is present in the host material at a concentration in a range 14 wt % to 25 wt %.

4. A composition according to claim 1, wherein the host material is blended with the phosphorescent emitter.

5. A composition according to claim 1, wherein the host material is bound to the phosphorescent emitter.

6. A composition according to claim 1, wherein the host material is a polymer.

7. A composition according to claim 1, wherein the phosphorescent emitter is a red emitter.

8. A composition according to claim 1, wherein the phosphorescent emitter comprises an Ir complex.

9. A composition according to claim 1, wherein the host material is a blue host material.

10. A pulsed-driven light emissive device including a composition as claimed in claim 1.

11. An organic light-emitting device containing a composition as defined in claim 1.

12. A pulsed-driven display comprising an organic light-emitting device as defined in claim 11.

13. A pulsed-driven display as claimed in claim 12 further comprising drive means for driving the display above a critical fusion frequency of a viewer.
